(19) United States
(12) Patent Application Publication
(10) Pub. No.: US 2014/0367579 A1
(43) Pub. Date: Dec. 18, 2014

(54) MEASURING APPARATUS AND SPECIMEN INFORMATION OBTAINING SYSTEM

(71) Applicant: CANON KABUSHIKI KAISHA, Tokyo (JP)

(72) Inventor: Yoichi Otsuka, Kawasaki-shi (JP)

(21) Appl. No.: 14/301,479

(22) Filed: Jun. 11, 2014

(30) Foreign Application Priority Data
Jun. 14, 2013 (JP) 2013-125723
Apr. 30, 2014 (JP) 2014-093888

(51) Int. Cl. G01N 21/17; G01J 1/42

(52) U.S. Cl. CPC G01N 21/17; G01J 1/42
USPC 250/372; 250/492.1

(57) ABSTRACT

A measurement apparatus includes a first light source unit configured to emit a first light having a first wavelength, and a scanning unit configured to move an irradiation position of the first light with respect to a specimen, so as to scan the specimen with the first light. The first light source unit includes a wavelength changing unit configured to change the first wavelength. Movement of the irradiation position is performed by the scanning unit while the wavelength changing unit is changing the first wavelength. A changing cycle of the first wavelength by the wavelength changing unit is shorter than a position moving cycle by the scanning unit.

### BACKGROUND OF THE INVENTION

1. Field of the Invention

The present invention relates to a measuring apparatus, and a specimen information obtaining system to obtain information of a specimen using measurement results from the measuring apparatus.

2. Description of the Related Art

There is a technology in which light is irradiated on a specimen for component analysis of the specimen, and the optical properties thereof are evaluated. As examples of this technology, Conor L. Evans et al., “Chemical imaging of tissue in vivo with video-rate coherent anti-stokes Raman scattering microscopy”, Proceedings of National Academy of Science of the United States of America, vol. 102, No. 46, 16807-16812 (2005) (hereinafter referred to as “Evans”) and Brian G. Saar et al., “Video-Rate Molecular Imaging in Vivo with Stimulated Raman Scattering” Science, vol. 330, No. 6009, 1368-1370 (2010) (hereinafter referred to as “Saar”) propose multiplexing two types of laser light having different wavelengths (first light and second light) and irradiating a specimen with the multiplexed light, to obtain specimen information based on the Raman spectrum.

Both methods obtain molecular vibration information of the specimen, taking advantage of the fact that Raman scattering occurs under a condition where a difference between vibration frequency ω1 of the first light and vibration frequency ω2 of the second light (hereinafter also referred to as “vibration frequency difference of multiplexed light”) matches a vibration frequency of molecules included in the specimen (where ω1>ω2). In either method, wavelength sweeping of at least one of the first and second wavelengths enables the vibration frequency difference of multiplexed light to be changed, and a Raman spectrum to be obtained over the range where the vibration frequency difference has been changed. The vibration frequency difference of multiplexed light is often converted into wavenumber with regard to the Raman spectrum, using the following conversion expression.

wavenumber difference Δγ=vibration frequency difference Δω/speed of light c vibration frequency difference Δω=2ω1−ω2 (in the reference by Evans), and vibration frequency difference Δω=ω1−ω2 (in the reference by Saar)

The wavenumber difference Δγ is the difference between the wavenumber of the first light and the wavenumber of the second light (hereinafter also referred to as “wavenumber difference of multiplexed light”, or simply “wavenumber difference”).

Evans proposes detecting a third light intensity generated when irradiating the multiplexed light, while Saar proposes detecting the intensity of one of the two types of light (first light or second light). Both methods have in common obtaining vibration information of molecules included in the specimen by detecting light from the specimen.

Also, a Raman image can be obtained by scanning the specimen using the multiplexed light, in either method. In a Raman image, a Raman spectrum obtained at a certain position in the specimen is used to form image pixels.

The methods disclosed in Evans and Saar require a process of irradiating multiplexed light of different wavenumber differences, on the same position in the specimen, to be performed multiple times. For example, to obtain a Raman spectrum in a wavenumber range of 100 cm⁻¹ to 1000 cm⁻¹, multiplexed light corresponds to a wavenumber difference of 100 cm⁻¹ is irradiated on a measurement area in the specimen, and the wavelength of the first or second light is changed to the other wavelength corresponds to a other wavenumber difference and the multiplexed light is irradiated on a same measurement area. By sweeping the wavelength of the first or second light, it is possible to obtain multiple Raman images that correspond to wavenumber differences up to 1000 cm⁻¹.

Accordingly, the measurement time and amount of measurement data increases in accordance with the size of the measurement range, and the number of multiplexed light used for scanning (two, in the case of a multiplexed light having a first wavenumber difference and a multiplexed light having a second wavenumber difference).

### SUMMARY OF THE INVENTION

In accordance with embodiments disclosed herein, a measurement apparatus includes a first light source unit configured to emit a first light having a first wavelength, and a scanning unit configured to move an irradiation position of the first light with respect to a specimen, so as to scan the specimen with the first light. The first light source unit includes a wavelength changing unit configured to change the first wavelength. Movement of the irradiation position is performed by the scanning unit while the wavelength changing unit is changing the first wavelength. A changing cycle of the first wavelength by the wavelength changing unit is shorter than a position moving cycle by the scanning unit.

Further features of the present invention will become apparent from the following description of exemplary embodiments with reference to the attached drawings.

### BRIEF DESCRIPTION OF THE DRAWINGS

FIG. 1 is a functional block diagram of a measurement apparatus according to an embodiment.

FIG. 2 is a diagram for describing wavelength sweeping of a first light, and scanning of a specimen using multiplexed light.

FIG. 3A is a diagram for describing an example of temporal change of displacement of an optical scanner and wavelength sweeping scanner.

FIG. 3B is a diagram for describing change of a first wavelength corresponding to displacement of the optical scanner and wavelength sweeping scanner illustrated in FIG. 3A, and movement of an irradiation position of multiplexed light.

FIG. 3C is a diagram for describing correlation between the irradiation position of multiplexed light and first wavelength corresponding to displacement of the optical scanner and wavelength sweeping scanner illustrated in FIG. 3A.

FIG. 4A is a diagram for describing an example of temporal change of displacement of an optical scanner and wavelength sweeping scanner.

FIG. 4B is a diagram for describing change of a first wavelength corresponding to displacement of the optical scanner and wavelength sweeping scanner illustrated in FIG. 4A, and movement of an irradiation position of multiplexed light.

FIG. 4C is a diagram for describing correlation between the irradiation position of multiplexed light and first wavelength corresponding to displacement of the optical scanner and wavelength sweeping scanner illustrated in FIG. 4A.

FIG. 5A is a diagram for describing an example of temporal change of displacement of an optical scanner and wavelength sweeping scanner.

FIG. 5B is a diagram for describing change of a first wavelength corresponding to displacement of the optical scanner and wavelength sweeping scanner illustrated in FIG. 5A, and movement of an irradiation position of multiplexed light.

FIG. 5C is a diagram for describing correlation between the irradiation position of multiplexed light and first wavelength corresponding to displacement of the optical scanner and wavelength sweeping scanner illustrated in FIG. 5A.

FIG. 5D is a diagram for describing correlation between the irradiation position of multiplexed light and first wavelength corresponding to displacement of the optical scanner and wavelength sweeping scanner illustrated in FIG. 5A, in which the phase difference between the two scanners was changed as illustrated.

FIG. 6 is a block diagram illustrating a measurement apparatus according to an embodiment.

FIG. 7 is a flowchart illustrating a process for irradiation and detection of light at various positions of a measurement specimen according to an embodiment.

FIG. 8 is a flowchart illustrating processes performed by a specimen information obtaining system executing wide-range scan and narrow-range scan in accordance with an embodiment.

### DESCRIPTION OF THE EMBODIMENTS

Performing a process of irradiating multiplexed light of different wavenumber differences, multiple times on the same position in the specimen, increases measurement time and amount of measurement data accordance with the size of the measurement range, and the number of multiplexed light used for scanning. At least one of the amounts of measurement time and amount of measurement data may be problematic.

A measurement apparatus which measures optical properties of a specimen by performing scanning of the specimen with light, and changing of the wavelength of the light. The measurement apparatus can reduce at least one of measurement time and measurement data amount.

The measurement apparatus according to the embodiment disclosed herein includes a scanning unit configured to scan a specimen with a first light, by moving an irradiation position of the first light on the specimen, and a wavelength changing unit configured to change a first wavelength which the first light has. The scanning unit moves the irradiation position of the first light while the first wavelength is being changed. Accordingly, the number of types of wavelengths irradiated on the same position of the specimen can be reduced as compared to the related art. Note that the related art as mentioned here refers to a measurement apparatus where the irradiation position of the first light is not moved while the first wavelength is being changed, such as with the measurement apparatus according to Evans and Saar described earlier.

Also note that the term “while the first wavelength is being changed” does not refer to an instant at which changing of the first wavelength is being performed (e.g., the instant of switching from λ1 nm to λ2 nm). In a case where the first wavelength is being changed by wavelength sweeping, the term “while the first wavelength is being changed” refers to the period during which the wavelength sweeping is being performed. In a case where the sweeping speed is sufficiently slow as compared to the speed of moving the irradiation position, the wavelength can be deemed to be unchanged (not swept) if we look only at the instant in which the irradiation position is moving. However, when the first wavelength is in the sweeping range (e.g., in a case of performing wavelength sweeping from λ1 nm to λ2 nm, when the wavelength is greater than λ1 nm and smaller than λ2 nm), the first wavelength can be deemed to be changing. The same can be said for a case where the wavelength is changed in stages; when the first wavelength is in the wavelength changing range, the first wavelength can be deemed to be changing. Hereinafter, in the present invention and the present specification, changing the wavelength in stages will also be referred to as sweeping the wavelength.

When the irradiation position is moved while the first wavelength is being changed, a partial region of the specimen (first region) is irradiated by the first light when the first wavelength is λ1, but another region (second region) is not irradiated by the first light. In the same way, when the first wavelength is λ2, the first region irradiated by the first light when the first wavelength is λ1 is not irradiated; instead, the second region is irradiated. There is no need to detect light from regions where the first light is not being irradiated, so this enables the amount of measurement data which would be obtained by measurement if measurement were performed to be reduced as compared to the related art.

Description of the present embodiment will be made in detail below by way of an example of a specimen information obtaining system capable of obtaining a Raman spectrum and Raman image, such as described in Evans and Saar. However, the present embodiment can be applied to other measurement apparatuses, as long as an apparatus which scans a specimen with a first light and can change the wavelength of the first light to measure the specimen. For example, the present embodiment is also applicable to a specimen information obtaining system which has a measurement apparatus which irradiates only one light on a specimen and measures transmissivity of a test object.

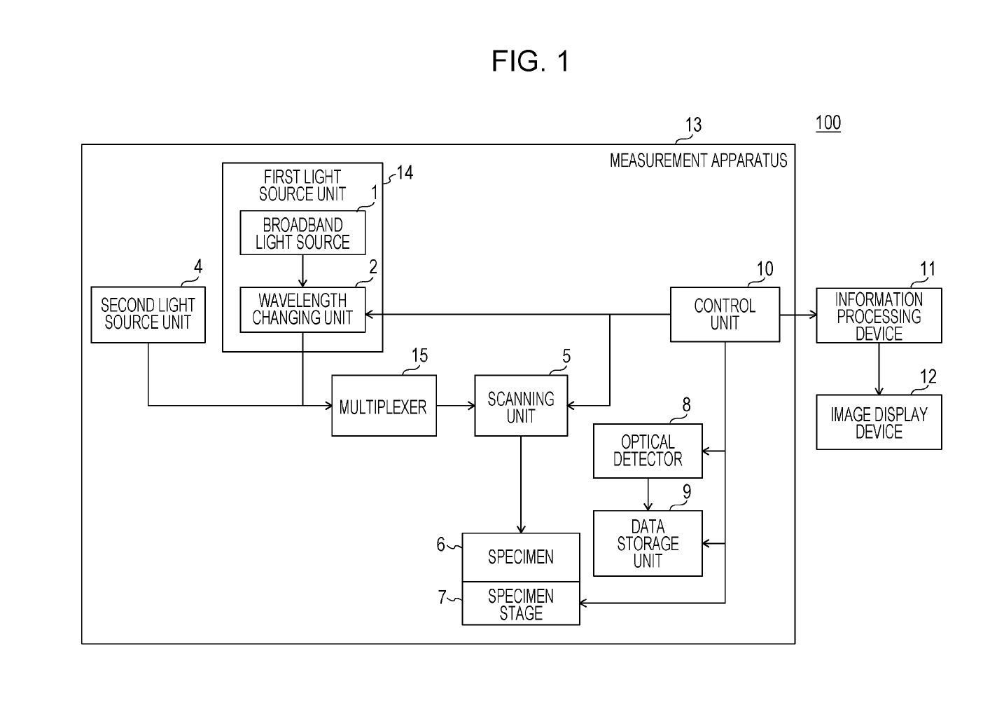

FIG. 1 is a functional block diagram of a specimen information obtaining system according to the present embodiment. The specimen information obtaining system 100 includes a measurement apparatus 13, an information processing device 11 which obtains information of optical properties of the specimen using the measurement results of the measurement apparatus 13, and an image display device 12 which displays images based information obtained by the information processing device 11. The measurement apparatus 13 includes a first light source 14 which emits the first light, a second light source 4 which emits second light, a multiplexer 15 which multiplexes the first light and second light, and a scanning unit 5 which scans a specimen 6 placed on a specimen stage 7 by multiplexed light multiplexed by the multiplexer 15. The measurement apparatus 13 also includes an optical detector 8 which detects light from the specimen, and a data storage unit 9 which receives light detected by the optical detector 8 as light signals. The components of the measurement apparatus 13 are electrically connected to a control unit 10. The control unit 10 controls the actions of the components.

The first light source 14 has a broadband light source 1 and a wavelength changing unit 2. The broadband light source 1 is a light source configured to generate light where multiple wavelengths of light have been mixed. The wavelength changing unit 2 according to the present embodiment is a spectral device which spectrally disperses the light from the broadband light source 1, to emit only light of an intended wavelength from the first light source 14.

The cycle of changing the first wavelength will also be referred to as a first wavelength change cycle. In the present invention and in the present specification, the term “cycle” is not restricted to something which is repeated. That is to say, even if changing of wavelength has occurred only once, the duration of that change is called a change cycle. For example, in a case of performing wavelength sweeping from λ1 nm to λ2 nm once, in a certain measurement, the amount of time required for the sweep is referred to as a change cycle. Also, in a case of repeating changing of wavelength, but the duration of the first wavelength change and the duration of the second wavelength change are not the same, while the first wavelength change is being performed the duration of the first wavelength change is the first wavelength change cycle, and while the second wavelength change is being performed the duration of the second wavelength change is the first wavelength change cycle. However, it is more desirable that repetition of wavelength change is performed by the wavelength changing unit 2 changing the wavelength of the first light (also referred to as “first wavelength) cyclically.

Note that the first light source 14 may have other configurations, as long as the first wavelength can be changed. For example, an arrangement may be made where the first light source 14 has multiple light sources each of which emit light only of a particular wavelength, and the first wavelength is changed by the light source being selected by the wavelength changing unit 2. In a case of using a light source which emits set wavelengths, that light source can be deemed to include the wavelength changing unit 2, and accordingly the wavelength changing unit 2 does not have to be provided separately.

The second light source 4 is a fixed-wavelength light source which emits second light. A “fixed-wavelength light source” is a light source which generates and emits light of a certain wavelength. Alternatively, a light source which can change the wavelength of the emitted light, such as the first light source 14, may be used instead of a fixed-wavelength light source.

The first light and second light include at least one of ultraviolet light, visible light, infrared light, and microwaves. The type of light is either continuous light or pulsed light. In a case of performing measurement using Raman scattering with the measuring apparatus according to the present embodiment, the first and second light are preferably laser light.

The first and second light are guided over the same optical path by the multiplexer 15 and multiplexed, and input to the scanning unit 5. The scanning unit 5 according to the present embodiment has a one-dimensional optical scanner which performs one-dimensional scanning of the specimen by moving a spot-shaped multiplexed light in one direction, and a specimen stage driving unit. The one-dimensional optical scanner performs one-dimensional scanning of the measurement range of the specimen, and the specimen stage moves in a direction which intersects the scanning direction of the one-dimensional optical scanner, thus enabling scanning of a two-dimensional measurement range. If we say that the scanning direction of the one-dimensional optical scanner is a first direction, and the moving direction of the specimen stage 7 is a second direction, the second direction preferably intersects with the first direction perpendicularly. Alternatively, instead of performing such scanning, scanning may be performed using only a two-dimensional light scanning unit which moves the multiplexed light, or scanning may be performed by moving the two-dimensional specimen stage 7 alone. In a case where measurement by one-dimensional scanning is sufficient, the specimen may be scanned by moving only the optical scanning unit or specimen stage 7, or the optical scanning unit and movement of the specimen stage 7 may be combined to perform one-dimensional scanning. The scanning range of the light can be specified by the scanning speed and scanning width of the scanning unit 5.

Cycles at which the irradiation position is moved will be referred to as a position movement cycle. Note however, that in the present invention and the present specification, the term “cycle” is not restricted to something which is repeated. That is to say, even if movement of position has occurred only once, the movement of that position is called a position movement cycle. For example, let us say that in a certain measurement, the irradiation position has moved from a position a(x1, y1) to position b(x2, y2), just once. In this case, the amount of time required for this movement is called position movement cycle. Also, in a case of repeating position movement, but the duration of the first position movement and the duration of the second position movement are not the same, while the first position movement is being performed the duration of the first position movement is the first position movement cycle, and while the second position movement is being performed the duration of the second position movement is the second position movement cycle. However, it is more desirable that when performing irradiation position movement repeatedly, the position movement is performed cyclically. Note that the first light scans the specimen two-dimensionally.

In a case where measurement by one-dimensional scanning is performed at position a(x1, y1) and position b(x2, y2), x1=x2, and y1≠y2 are true, or x1≠x2 and y1=y2 are true. On the other hand, in a case of performing two-dimensional scanning for the measurement, x1≠x2 and y1≠y2 are true.

The multiplexed light is irradiated onto the specimen 6 placed on the specimen stage 7, and the optical detector 8 detects the light from the specimen 6. The light detected at the optical detector 8 is at least one of X-rays, ultraviolet light, visible light, infrared light, microwaves, fluorescent light, phosphorescence, and secondary electrons. Examples of origin of detected light include coherent Raman scattering, induced Raman scattering, and so forth. In a case of application to a measurement apparatus which does not use Raman scattering, examples of origin of detected light include second harmonic generation, third harmonic generation, induced Brillouin scattering, induced Compton scattering, light reflection, light scattering, light transmission, and so forth. Two or more phenomenon may be used as the origin. In any case, the intensity of light is detected at the optical detector 8. The optical detector 8 is arranged so that the detection surface thereof faces one of the front face, side face, and back face of the specimen 6.

Light signals obtained by the optical detector 8 detecting the intensity of the light is output to the data storage unit 9, and stored as digital data in the data storage unit 9. The stored data is output to the information processing device 11.

The information processing device 11 according to the present embodiment performs various types of computation using the digital data stored in the data storage unit 9, and obtains information of the optical properties of the specimen 6 (hereinafter may be referred to as “specimen information”) and image information based thereupon. Note that the term “optical properties” refers to the entirety of properties measured by irradiating light on the specimen 6, properties obtained by information processing based on the measurement results obtained by the measurement.

The image information obtained at the information processing device 11 is output to an image display device 12 such as a flat-panel display. The image display device 12 receives input of image information and displays images based on the image information. Image information as used here is information of intensity distribution of light from the specimen 6, obtained at each wavenumber of the multiplexed light, for example, or information of a graph indicating correlation of light intensity from the specimen 6 as to multiple wavenumber differences (Raman spectrum). The image information may also be Raman image information where a Raman spectrum obtained from multivariable analysis (multivariate analysis) such as main component analysis or independent component analysis has been plotted, information of an image obtained of the specimen 6 by an optical microscope or the like, or other such information.

In a case where the specimen 6 is to be irradiated without the first light and second light being multiplexed, the information may be information of light intensity distribution from the specimen 6 obtained for each wavelength of the first light, information of a graph indicating correlation of light intensity from the specimen 6 as to multiple first wavelengths, information obtained by multivariable analysis, or the like. The image information may be that of a one-dimensional image, a two-dimensional image, or a three-dimensional image. Images based on each image information may be displayed separated from each other, or multiple images may be overlaid and displayed. Also, a printer may be used as the image display device 12 so as to display images by the printer printing images based on the image information, and further, an arrangement may be made where both a display and printer are provided as the image display device 12.

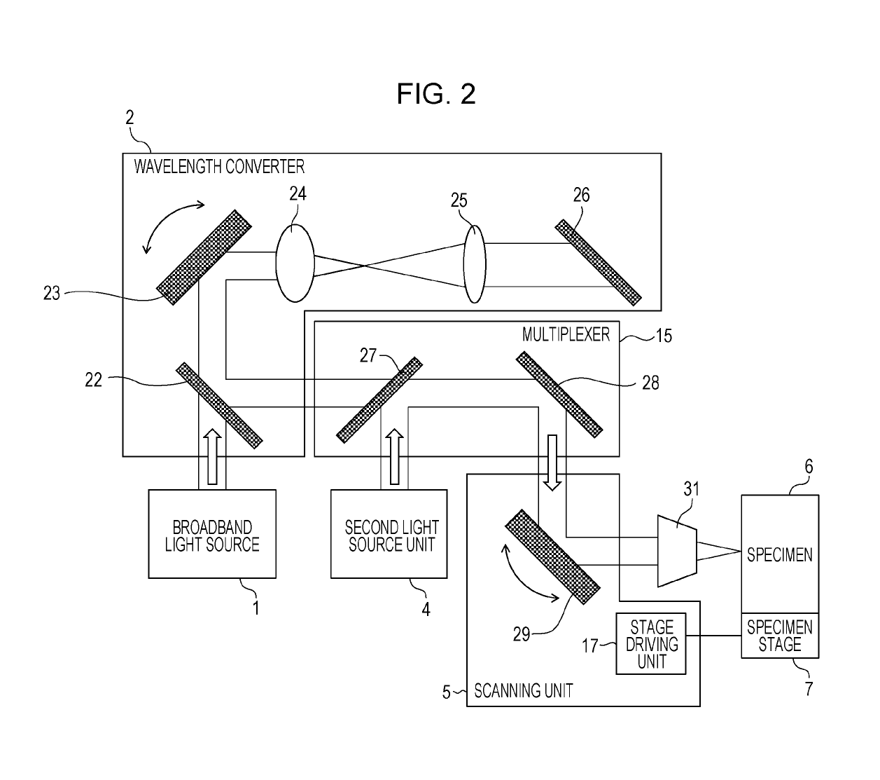

Wavelength sweeping of the first light, and scanning of the specimen 6 by multiplexed light, according to the present embodiment, will be described with reference to FIG. 2. FIG. 2 is a schematic diagram illustrating an example of the wavelength changing unit 2 and broadband light source 1 which the first light source 14 has, the second light source 4, multiplexer 15, and scanning unit 5. In the example illustrated in FIG. 2, the wavelength changing unit 2 includes a half mirror 22, a wavelength sweeping resonant scanner 23, convex lenses 24 and 25, and a grating 26. The multiplexer 15 includes half mirrors 27 and 28, and the scanning unit 5 includes an optical scanning resonant scanner 29 and a specimen stage driving unit 17.

Light having a broad wavelength band that has been released from the broadband light source 1 passes through the half mirror 22, and then is reflected at the mirror of the wavelength sweeping resonant scanner 23. A resonant scanner is a device which vibrates a mirror at high speed using mechanical resonance. The reflected light passes through the two convex lenses 24 and 25 and then is input to the grating 26. The grating 26 has a Littrow arrangement, and is situated such that the distance between the mirror of the wavelength sweeping resonant scanner 23 and the convex lens 24 is equal to the focal distance of the convex lens 24, and the distance between the grating 26 and the convex lens 25 is equal to the focal distance of the convex lens 25. Such an optical system is a 4 f optical system, and can disperse the light from the broadband light source 1 so as to extract light of a particular wavelength, by adjusting the mirror angle of the wavelength sweeping resonant scanner 23. This particular wavelength obtained by dispersing is the first light.

The first light is input to the optical scanning resonant scanner 29 used for optical scanning, via at least two half mirrors 22 and 27, and at least one mirror 28. The second light emitted from the second light source 4 which is a fixed-wavelength light source is multiplexed coaxially with the first light, via at least one half mirror 27 and the mirror 28. The multiplexed light (first light and second light) is input to the optical scanning resonant scanner 29 for optical scanning, scanned in the one-dimensional direction by mirror vibrations of the optical scanning resonant scanner 29 for optical scanning, and irradiated onto the specimen 6 via an object lens 31. In the present invention and present specification, scanning the specimen 6 with the multiplexed light where the first light and second light have been multiplexed, is also deemed to be included in scanning the specimen 6 with the first light. Also, in the present invention and present specification, the irradiation position of the multiplexed light where the first light and second light have been multiplexed, is also deemed to be included in the irradiation position of the first light.

In the present embodiment, the first and second light are multiplexed on the same optical axis, and then one-dimensionally scanned in the first direction. The irradiation position of the multiplexed light is moved while the first wavelength is swept within a particular range by the wavelength changing unit 2 according to the present embodiment. By the irradiation position of the multiplexed light being moved while the first wavelength is being swept, the first wavelength included in the multiplexed light irradiated at each position differs. Accordingly, multiplexed light having different wavenumber differences can be irradiated at adjacent regions within the scanning range.

Now, one-dimensional scanning is one of one-directional and bi-directional. One-directional means scanning in one direction from the start position of the scan to the end position, and bi-directional scanning means reciprocal scanning where the scanning is performed from the start position of the scan to the end position, and the returns from the end position to the start position while scanning.

After having performed one-dimensional direction scanning in the one-dimensional scanning range, the specimen stage 7 is driven and the irradiation position of the multiplexed light as to the specimen 6 is moved into a direction intersecting the scanning direction. Thereafter, one-dimensional direction scanning is performed again by the optical scanning resonant scanner 29. Accordingly, a one-directional region different than before the specimen stage 7 was driven, can be scanned, by continuously performing this process, measurement of a two-dimensional region and be performed. In a case where the scanning unit 5 is capable of performing both scanning in the one-dimensional direction, and moving the irradiation position in a direction intersecting the scanning direction (i.e., in a case where the scanning unit 5 is a two-dimensional scanning unit), driving of the specimen stage 7 is unnecessary.

In the related art, the full range of wavelengths used for measurement have been irradiated on each irradiation position and light detected form the specimen, rather than performing sweeping of the first wavelength while the irradiation position of the multiplexed light is being moved. Accordingly, the measurement data amount obtained by measurement can be expressed as follows.

(measurement data amount)∝(total number of irradiation positions)×(total number of wavenumber differences of multiplexed light)

In a case where the first light is to be irradiated on the specimen 6 rather than using multiplexed light, the total number of wavenumber differences of the multiplexed light in the above expression (hereinafter may be referred to as “wavenumber difference total”, and represented by n, where n≧2) is the total number of first wavelengths (the total number of first wavelengths is two in a case where the first wavelength only assumes λ1 and λ2).

Thus, the detection results of wavenumber differences have been obtained for each measurement position in the related art, which could lead to increase in measurement time and measurement data amount.

On the other hand, the present embodiment can reduced the measurement data amount from that of the related art. For example, if the irradiation position is moved for each change in the first wavelength, and the number of wavenumber differences irradiated as to one irradiation position is represented by p, the measurement data amount can be expressed as

(measurement data amount)∝(total number of irradiation positions)×p

where n>p and p≧1 hold.

Detection results are obtained when irradiating only multiplexed light having p wavenumber differences to each irradiation position, and this becomes the measurement data, so the measurement data amount can be reduced as compared to the related art. The amount which can be reduced is proportionate to the inverse of the wavenumber difference total n, and the wavenumber differences p irradiated as to a single irradiation position. Accordingly, the greater n is, or the smaller p is, the more markedly this effect is exhibited.

For example, at the time of measuring a specimen, the related art yields measurement data n-fold the irradiation positions total. Applying the present embodiment and measuring the wavenumber differences irradiated as to a single irradiation position as p means that the amount of measurement data is p times the irradiation position total, so the measurement data amount can be reduced to p/n that of the related data. Note that p can be approximated by dividing the position movement cycle by the change cycle of the first wavelength. For example, if the change cycle of the first wavelength is 4 ms, and the position movement cycle is 8 ms, p≈2.

If we assume that the rate of wavelength change is constant within the wavelength change range, and that the scanning speed within the scanning range is constant, the measurement time is also proportionate to the total number of irradiation positions and the number of wavenumber differences irradiate as to a single irradiation position. That is,

(measurement time)∝(irradiation position total)×p

holds, so the measurement time can be reduced if n>p.

In a case where the wavenumber difference irradiated to one measurement position is one, the intensity of light can be detected from the specimen when multiplexed light of a certain wavenumber difference (first wavenumber difference) is irradiated as to a certain irradiation position (first region). However, the intensity of light from the specimen when multiplexed light of a different wavenumber difference (second wavenumber difference) is irradiated as to that position (first region) cannot be known. Accordingly, at the information processing device in the present embodiment, the detection results obtained in the scanning direction are integrated, and the detection results of having illuminated different irradiation positions (first and second regions) by multiplexed light is deemed to be the detection results of having illuminated the same irradiation position (fourth region) by multiplexed light, thereby obtaining specimen information. However, this is a Raman spectrum obtained by integrating detection results at a different measurement position, there is the possibility that this may be different from the actual data. That is to say, if detection results m measurement positions are integrated, detection results actually detected at m irradiation positions are subjected to information processing has being detection results detected at one irradiation position, so the spatial resolution decreases by 1/m times in simple terms. Now, at the time of deeming the detection results detected when irradiating the first region with multiplexed light, and the detection results detected when irradiating the second region with multiplexed light, are deemed to be detection results detected when irradiating the fourth region with multiplexed light, the fourth region may be either the first region or second region. Alternatively, the fourth region may be a region which does not match either the first region or second region. For example, an intermediate region between the first region and second region may be taken as the fourth region.

The present embodiment is more effective when used in cases where high-speed acquisition of specimen information, or reduction in the amount of measurement data, as compared to using when obtaining specimen information accurately or precisely. Also, an arrangement may be made of a measurement apparatus which enables selection between a high-speed measurement mode where the irradiation position is moved while performing wavelength sweeping and measurement is performed as with the present embodiment, and a normal measurement mode where the irradiation position is not moved while performing wavelength sweeping, and measurement is performed as with the related art. Further, an arrangement may be made where one measurement mode can be selected from several types of high-speed measurement modes, as suitable in accordance with the measurement speed or measurement data amount.

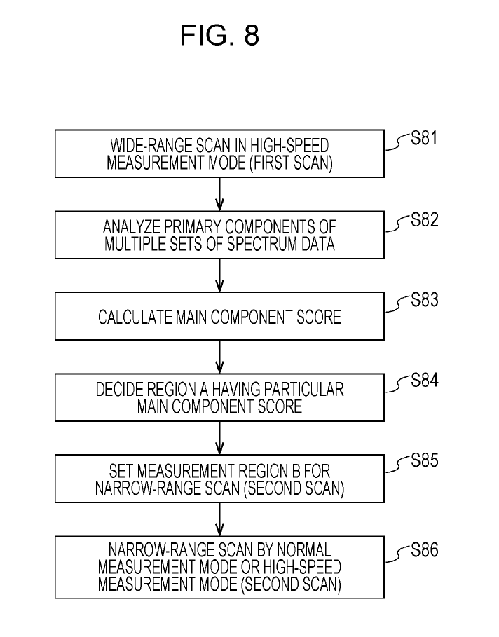

Also, the high-speed measurement mode and normal measurement mode or multiple types of high-speed measurement modes may be combined to perform measurement. For example, a specimen having a size of several millimeters to several centimeters such as body tissue may be scanned in a first instance over a wide range in high-speed measurement mode to obtain general information of the overall specimen. That general information is then used to determine a region of interest to be measured in detail, and narrow-range scanning is performed in a second instance to measure the region of interest either in the normal measurement mode or a high-speed measurement mode. Accordingly, in the first instance a wide-range scanning (first scan) can be performed, and in the second instance a narrow-range scanning (second scan) that is more detailed than the first scan can be performed. The position to be measured in detail may be decided by multivariable analysis. FIG. 8 illustrates exemplary processes performed by a specimen information obtaining system executing wide-range scan and narrow-range scan in accordance with an embodiment. In the process of FIG. 8, a wide-range scan is performed by high-speed measurement mode (also referred to as “first scan”) at step S81. At steps S82, S83 and S84, settings of measurement range are performed according to main component analysis. Following the first scan, a narrow-range scan is performed in normal measurement mode or a second high-speed measurement mode, at step S85; this is referred to as a “second scan”. In the main component analysis, the control unit 10 (in FIG. 1) calculates a score value (S83) by main component analysis from the measurement results (e.g., spectrum data) obtained at S82 from the first scan in the high-speed measurement mode. At step S84, the control unit 10 extracts a region A where the score value of a particular main component matches set conditions. Setting of conditions may be performed by a user performing measurement inputting the conditions beforehand, or an image processing apparatus may decide the conditions based on modes and measurement objects selected by the user. At step S85, the control unit 10 sets the region A or part thereof obtained at S84 as a region B to be studied in further detail. After setting the region B for narrow-range scan, control unit 10 controls measurement apparatus 13 to perform a second scan in normal measurement mode or high-speed measurement mode, at step S86. This process of steps S81 to S85 may be iteratively repeated to further narrow the measurement region B, if necessary. Note however, that even in a case of performing the second scan by high-speed measurement mode, this measurement is performed in more detail that the high-speed measurement mode of the first scan. That is, in the second scan, the number of wavenumbers irradiated to one location (region B) is increased as compared to another location (region A) in the first scan. The number of wavenumbers to be irradiated to one location can be made to be more than that for the first scan by making the frequency of wavelength sweeping in the second scan N times the frequency of wavelength sweeping in the first scan. Alternatively, the frequency to scan the irradiation position in the second scan may be made 1/N times the frequency used to scan the irradiation position in the first scan. In a case where the number of measurement regions A is large, regions where the percentage of measurement region A is large by unit area may be extracted, prioritized and ordered, and higher order measurement regions set as measurement region B. Setting the measurement region A and extracting regions B matching setting conditions may be performed by the information processing device 11 (an external device), or setting the measurement region may be performed manually (by user input). This method enables detailed analysis of smaller measurement regions as compared to analysis of a large measurement region where the high-speed measurement mode was performed. That is, this method enables small regions to be measured with detailed position information, so measurement time or measurement data amount can be reduces as compared to obtaining data of the entire region in the normal measurement mode. Accordingly, effective analysis can be performed on selected regions of large measurement objects in particular.

The main component analysis of spectrum data obtained by the first scan will be described in detail. Detection results at m adjacent measurement positions are integrated in the first scan, thereby obtaining spectrum data (also referred to as “average spectrum data”). More particularly, data where m detection results are correlated to m is taken as the average spectrum data. Multiple sets of average spectrum data are obtained in the first scan. If we way that the number of sets of average spectrum data is k, the average spectrum data obtained in the first scan can be converted and expressed as an m-row by k-column matrix (also referred to as “first spectrum data”). A variance-covariance matrix of the matrix is calculated, and eigenvalues are calculated for the obtained m-row by m-column matrix, thereby obtaining eigenvectors and eigenvalues. Each eigenvector is an m-dimensional vector, and the eigenvalues are scalar. Sorting in eigenvalues from the largest enables eigenvectors which can maximize variance of the first spectrum data to be sorted and stored in order. The sorted eigenvectors are selected from those of higher order. The number of eigenvectors may be set optionally, or may be set based on a threshold value decided beforehand. Calculating the inner product of each average spectrum data by the eigenvectors yields a score from each average spectrum data for each eigenvector. After the score value has been calculated for all sets of average spectrum data, score values matching certain conditions such as being within a certain numerical value range, equal or above a threshold value, smaller than a threshold value, or the like, are extracted. Thus, the spectrum data measurement positions corresponding to the conditions can be identified. This process is a process for deciding regions A having a particular main component score. The data of the region A obtained here includes information of multiple measurement positions.

Next, regions B are set from the information of multiple measurement positions included in the regions A. This process is a process for setting measurement regions B for the second scan. An example of the setting method thereof includes performing numerical value computation of the density of region A measurement positions, and extracting regions having density at or above a certain threshold value. Arranging the measurement region B setting processing in this way allows the number of measurement positions included in the region B to be reduced as compared to the measurement positions included in the region A, and accordingly for the number of measurement regions of the second scan perform after this to be reduced. Reduction in the number of measurement regions of the second scan enables the measurement time and spectrum data size to be reduced.

While setting of regions A and regions B based on main component analysis has been described here, other multivariable analysis techniques may be used. Examples of other multivariable analysis techniques include cluster analysis, factor analysis, discriminant analysis, and so forth.

The number of multiplexed light to be irradiated at one irradiation position can be decided in accordance to the object of measurement. The scanning frequency, wavelength sweep frequency, and phase difference may be taken into consideration at this time. For example, if we way that the scanning frequency is 100 Hz and the wavelength sweep frequency is 100N (where N is a natural number) Hz, the number of measurement positions where light of the same wavenumber is irradiated is N times that of a case where the wavelength sweep frequency is 100 Hz. Accordingly, this makes up for fewer detection results as compared to the case where the wavelength sweep frequency is 100 Hz.

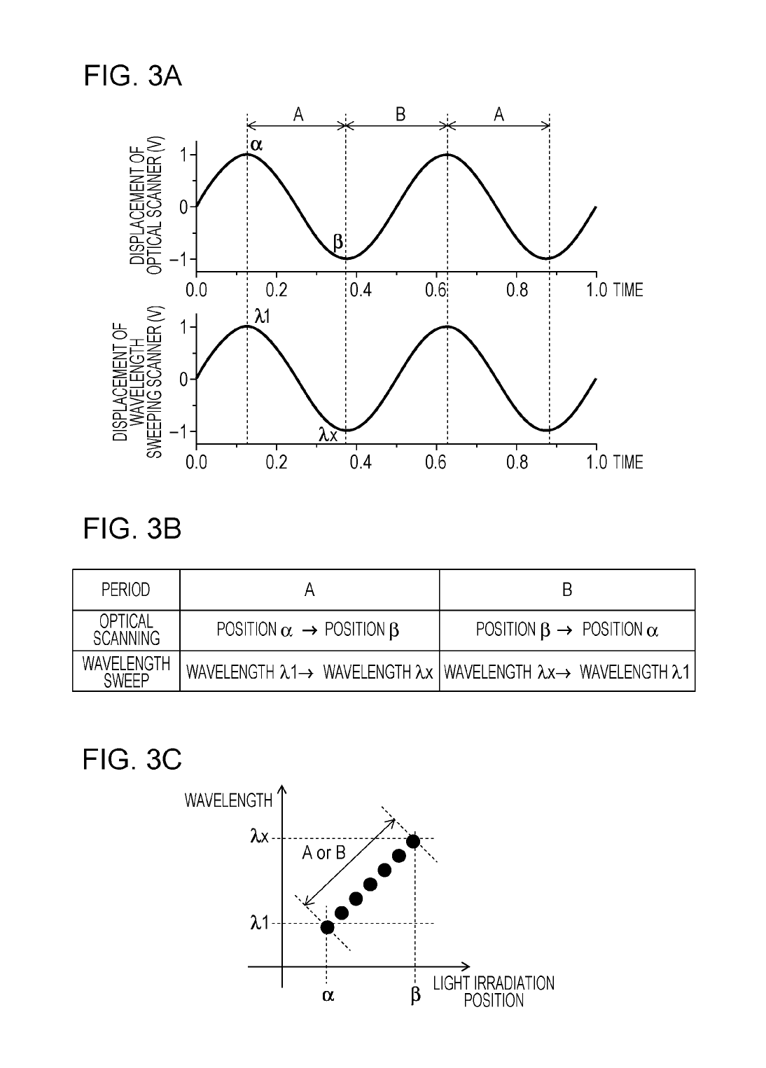

An example of correlation between movement of the irradiation position due to scanning, and the wavelength irradiated at the irradiation position, will be described with reference to FIGS. 3A through 3C. FIG. 3A illustrates temporal change of displacement of an optical scanning resonant scanner and wavelength sweeping resonant scanner. Displacement of both scanners has been standardized so as to be between +1 and −1. The optical scanning resonant scanner and wavelength sweeping resonant scanner here correspond to the optical scanning resonant scanner 29 and the wavelength sweeping resonant scanner 23 illustrated in FIG. 2. The displacement of each scanning cyclically changes. The frequency thereof will be referred to as the resonance frequency of the scanners. A case will be described here where both scanners have the same resonance frequency, and where the phase of displacement cycles match.

Displacement of the optical scanning resonant scanner 29 alternates between periods A and B, so that multiplexed light can be irradiated to position α when the displacement is the greatest value (+1), and multiplexed light can be irradiated to position β when the displacement is the smallest value (−1). Accordingly, the one-dimensional region between α and β is scanned by multiplexed light. Note that the position movement cycle here is period A (which is equal to period B), but not limited thusly in cases of performing two-dimensional scanning. In a case where two-dimensional scanning is to be performed, and we say that the one-dimensional region between α and β is rows and the one-dimensional region between α and γ is columns, time obtained by multiplying A by the number of columns is the position movement cycle. In cases where the optical scanning resonant scanner 29 and other driving arrangements (e.g., specimen stage) are to be combined to scan the specimen, the cycle of displacement of the optical scanning resonant scanner 29 and the position movement cycle do not match.

Displacement of the wavelength sweeping resonant scanner 23 similarly alternates between periods A and B, so that light of wavelength λ1 can be irradiated when the displacement is the greatest value (+1), and light of wavelength λx can be irradiated when the displacement is the smallest value (−1) where x is a natural number. Note that the change cycle of the first wavelength here is period A (which is equal to period B).

The displacement of the wavelength sweeping resonant scanner 23 corresponds to the wavelength of the first light, so different wavelengths from wavelength λ1 to wavelength λx are continuously irradiated as time advances in periods A and B. Note that the actual wavelengths of λ1 and λx have been measured beforehand, and are known values at the time of performing measurement. Change of the first wavelength and change of the irradiation position in each of the periods A and B are illustrated in FIG. 3B. In a case where the optical scanning resonant scanner 29 and the wavelength sweeping resonant scanner 23 exhibit displacement at the same frequency, and the phase of the cycles are also the same, the correction between the irradiation position of the multiplexed light and the first wavelength is a linear relation, as illustrated in FIG. 3C. The advantage of this system where the optical scanning resonant scanner 29 and wavelength sweeping resonant scanner 23 are displaced is that the electronic circuit to drive the scanners is simple, and acquisition of data from the optical detectors is easy.

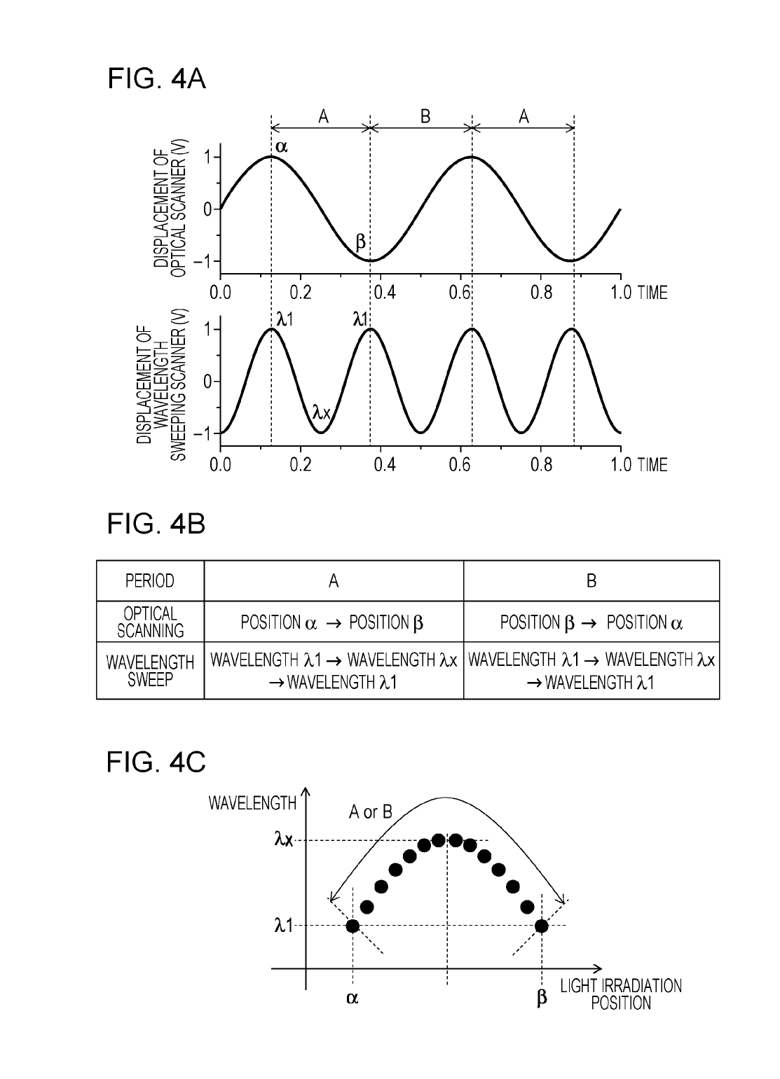

Next, a case where displacement of the optical scanning resonant scanner 29 and wavelength sweeping resonant scanner 23 occurs at different frequencies sill be described with reference to FIGS. 4A through 4C. FIG. 4A illustrates temporal change of displacement of the optical scanning resonant scanner 29 and wavelength sweeping resonant scanner 23. Unlike the system illustrated in FIGS. 3A through 3C, the wavelength sweeping resonant scanner 23 is displaced at twice the frequency of the optical scanning resonant scanner 29. The phase difference in displacement cycles is zero. The change in first wavelength and the change in irradiation position in each of the periods A and B are illustrated in FIG. 4B.

As illustrated in FIG. 4B, the first wavelength changes from λ1 to λx and back to λ1 in the period A where the irradiation position of the multiplexed light changes from α to β. That is to say, the position movement cycle is twice the change cycle of the first wavelength. Accordingly, the number of times of wavelength sweeping is twice in periods A and B as compared to that according to the system described with FIGS. 3A through 3C. The correlation of the irradiation position of the multiplexed light and the first wavelength in each of the periods A and B is a quadratic curve, as illustrated in FIG. 4C. To generalize this system, in a case where the irradiation position moving cycle is a positive integer multiple (N times) the change cycle of the first wavelength, the wavelength sweeping is performed N times for the same sweeping range in the one-dimensional region. That is to say, wavelength sweeping is performed N times for one one-dimensional scan (scanning from α to β), the one-dimensional scanning region as to one wavelength sweep is smaller. Accordingly, integrating the detection results obtained from the measurement of period A/N or B/N enables optical property information of the change of the first wavelength from λ1 to λx to be obtained. Consequently, the degree to which the irradiation position is averaged can be reduced.

For example, in the system described with reference to FIGS. 3A through 3C, if information of optical properties at the time of the first wavelength changing from λ1 to λx is to be obtained, the detection results obtained by measurement during the period A (or B) need to be integrated, since N=1. On the other hand, with the system described with reference to FIGS. 4A through 4C, information of optical properties at the time of the first wavelength changing from λ1 to λx can be obtained by integrating the detection results obtained by measurement during the period A/2 (or B/2), since N=2. The first wavelength change cycle can be made to be an integer multiple of the irradiation position movement cycle by driving the optical scanning resonant scanner 29 at f Hz and driving the wavelength sweeping resonant scanner 23 at fN Hz. This method where the wavelength change cycle is obtained by dividing the irradiation position movement cycle by a positive integer has few multiplexed light types to measure. This is advantageous in cases where a certain level of increase in measurement data is permissible, and cases where the degree of averaging irradiation positions is to be reduced to maintain accuracy or precision by a certain amount. N may be determined as appropriate, taking in to consideration the measurement data amount, measurement time, and accuracy or precision of measurement. Also, an arrangement may be made where several high-speed measurement modes are prepared, and the measuring apparatus automatically sets N in accordance with the mode which the user has selected. One method to realize multiple Ns is to switch between multiple wavelength changing units 2 including resonant scanners having different resonant frequencies. In this case, light generated at the broadband light source 1 may be input to different wavelength changing units 2 using a mirror or the like.

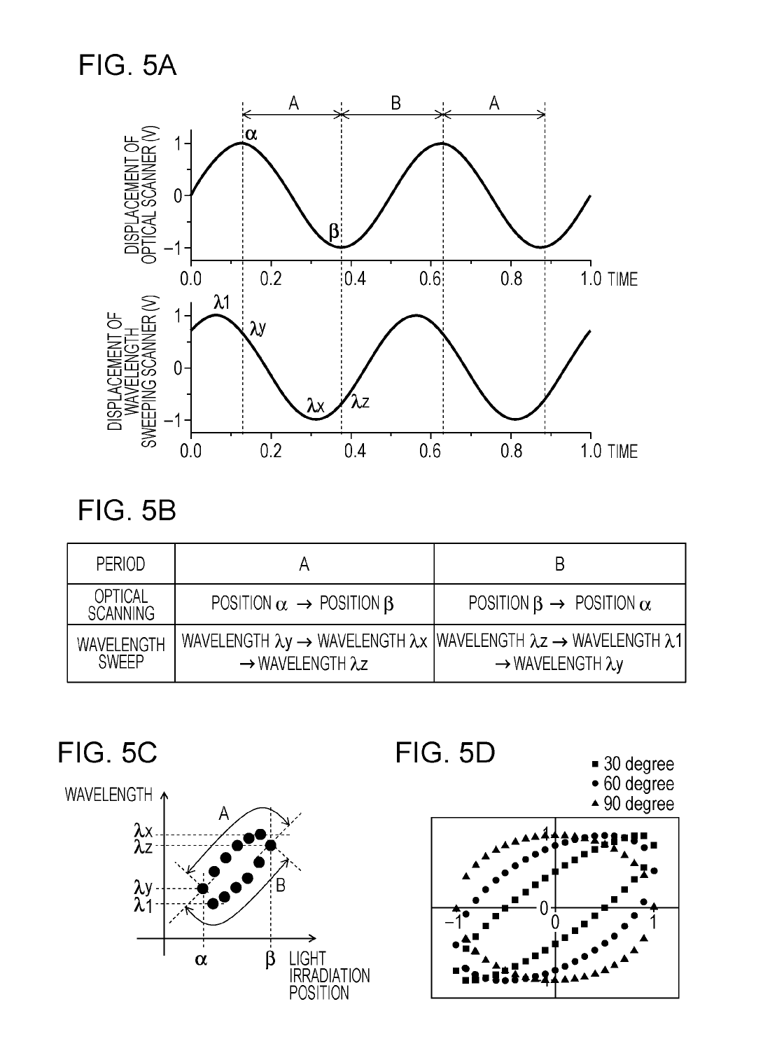

Next, a case where the optical scanning resonant scanner 29 and wavelength sweeping resonant scanner 23 are displaced at the same frequency, and the phases of the displacement cycles are not the same, will be described with reference to FIGS. 5A through 5D. FIG. 5A illustrates temporal change of the displacement of the optical scanning resonant scanner 29 and wavelength sweeping resonant scanner 23. Unlike the system illustrated in FIGS. 3A through 3C, the phase of displacement cycle of the optical scanning resonant scanner 29 and the phase of displacement cycle of the wavelength sweeping resonant scanner 23 are designed to be offset. The frequency is the same.

The change in the first wavelength and the change in irradiation position in each of periods A and B are illustrated in FIG. 5B. In the system described with reference to FIGS. 3A through 3C, the phase of displacement cycles of the two scanners match, so the timings of the greatest value (+1) and smallest value (−1) of the displacements match. Accordingly, the correlation between the multiplexed light irradiation position and the first wavelength is a linear relation as illustrated in FIG. 3C. On the other hand, with the system illustrated in FIGS. 5A through 5D, light of different wavelengths is irradiate in each of the periods A and B.

The correlation between the multiplexed light irradiation position and first wavelength when the amount of phase shift of the displacement cycle of the scanners (hereinafter, also referred to as “phase difference”) is changed, is illustrated in FIG. 5D. As the amount of phase shift increases, the separation between the wavelength region irradiate in period A and the wavelength region irradiate in period B increases. Thus, the advantage of shifting the phase of scanning cycles of the irradiation position, and the phase of the sweeping cycle of the first wavelength, is that two types of wavelengths can be irradiated to the same irradiation position. This can be done by making the one-dimensional scan performed in period A and the one-dimensional scan performed in period B to be one set, and performing one-dimensional scanning in period A and period B as to the same one-dimensional region of the specimen 6. Changing of the first wavelength is preferably performed in one direction. That is to say, in a case of changing from λ1 to λx, the wavelength increases (or decreases) continuously or in stages from λ1 to λx, and once the first wavelength reaches λx, the wavelength decreases (or increases) continuously or in stages to λ1 again. However, changing the first wavelength in one direction means that even if multiplexed light including multiple types of light is irradiated as to the same irradiation position, the multiplexed light difference between the first wavelengths included in the multiplexed light is small.

Using this method allows the multiplexed light difference between the first wavelengths included in the multiplexed light irradiated to the same irradiation position to be great, even when changing the first wavelength in one direction. Also, adjusting the phase shift amount enables the difference between the first wavelengths to be adjusted. Further, performing measurement multiple times with the phase shift amount changed each time enables the number of first wavelengths to be irradiated to the same irradiation position to be increased optionally. Using this system to perform measurement multiple times with the phase shift amount changed each time enables faster measurement than that described in Saar. Accordingly, measurement equivalent to the method according to the related art where measurements of the same measurement position are made using different wavelengths each time can be performed, and faster than the related art. In this case, the measurement data amount is the same as with the related art. Note that when carrying out this system, a condition may be set that the range where the first wavelength is changed in period A and the range where the first wavelength is changed in period B do not match under the condition that the phase difference is set to be zero. Accordingly, the frequency of displacement of the optical scanning resonant scanner 29 and the frequency of displacement of the wavelength sweeping resonant scanner 23 do not have to be the same, and it is sufficient for the frequency of the wavelength sweeping resonant scanner 23 to be an odd multiple of the frequency of the optical scanning resonant scanner 29. That is to say, it is sufficient for the cycle of changing position to be an odd multiple of the changing cycle of the first wavelength.

Note that in the present invention and the present specification, phase shift does not include phases shifted by π, such as one phase being −1 and the other phase being +1, for example.

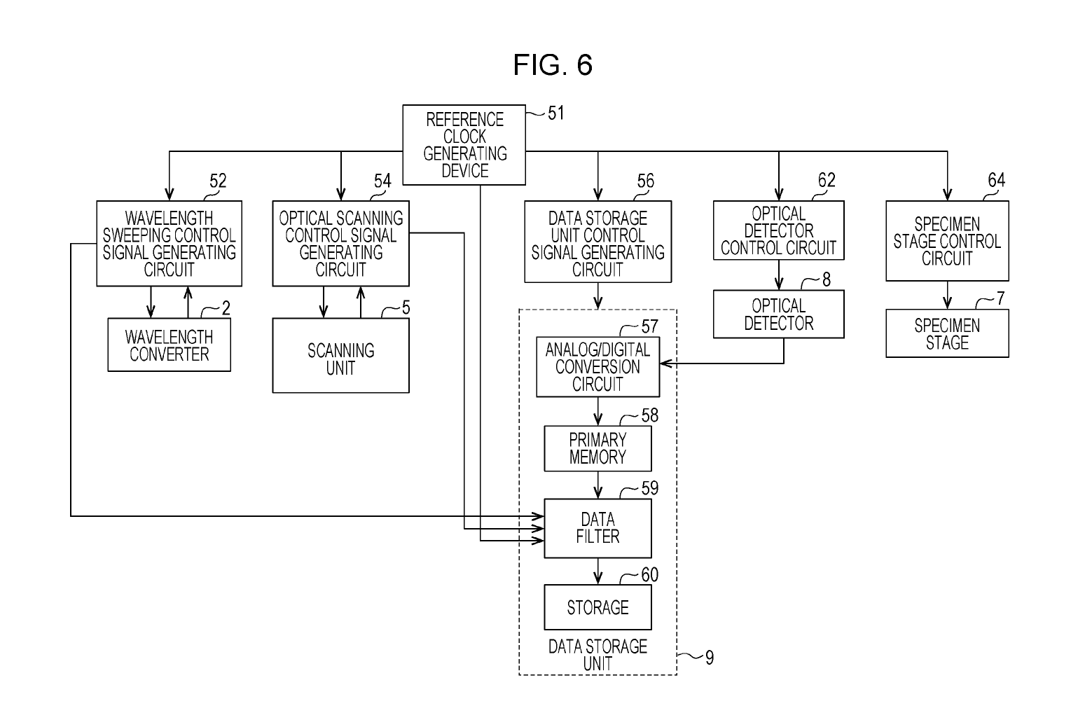

Next, detection of light by the optical detector 8 will be described. When obtaining measurement data, the irradiation position movement cycle, the first wavelength change cycle, and timing of optical detection by the optical detector 8 need to be adjusted, and optical detection performed at a particular timing. FIG. 6 illustrates an exemplary embodiment of a measurement apparatus. The measurement apparatus in FIG. 6 includes a reference clock generating device 51, a wavelength sweeping control signal generating circuit 52, the wavelength changing unit 2, an optical scanning control signal generating circuit 54, the scanning unit 5, a data storage unit control signal generating circuit 56, the data storage unit 9, an optical detector control circuit 62, the optical detector 8, a specimen stage control circuit 64, and the specimen stage 7. The data storage unit 9 includes an analog/digital conversion circuit 57, primary memory 58, a data filter 59, and storage 60.

An example will be described here of a case of using a field programmable gate array (FPGA) or application specific integrated circuit (ASIC). Thus, the multiple control circuits (51, 52, 54, 56, 62, and 64) are implemented on an integrated circuit, so the control timing thereof can be accurately adjusted and at high speed.

First, voltage signals are generated at the wavelength sweeping control signal generating circuit 52 and optical scanning control signal generating circuit 54, based on a reference clock, and output to the wavelength changing unit 2 and optical scanning unit 5. In a case of performing wavelength sweeping and scanning using resonant scanners such as illustrated in FIG. 2, this method can be used to generate the voltage signals to vibrate the resonant scanners. The phase of the voltage signals is generated so that the phase difference as to a detection signal corresponding to actual vibrations of the resonant scanners and the phase difference as to a reference signal generated based on the reference clock is zero, by driving a feedback circuit. Accordingly, the resonant scanners can be vibrated at a certain frequency. This driving mechanism is known as phase locked loop (PLL). Voltage signals having an optional delay time as to the reference signal can be generated by providing a delay compensation circuit within a circuit for PLL. Using two PLLs enables the phase of the cycle of the wavelength sweeping resonant scanner 23 and the phase of the cycle of the optical scanning resonant scanner 29 to be shifted. The reference clock may be that of an internal clock of the FPGA or ASIC or the like, or a signal of an external clock generator may be input to the FPGA or ASIC. A device such as a PLD-2S DRIVER manufactured by Electro-Optic Products Corp. may be used to control and drive the phase difference of displacement of the two resonant scanners. However, adjustment of phase shift amount is performed manually, and is difficult to adjust at high speed, so the electronic circuit preferably has multiple PLLs implemented.

Next, a method to store the voltage signals from the optical detector 8 as digital data will be described. Control signals to drive the optical detector 8 are generated at the optical detector control circuit 62 and output, based on the reference clock. Control signals here are a signal for turning the operation of the optical detector 8 on and off, a data obtaining timing control signal, and a reference signals for synchronous detection at the optical detector 8. For example, if the incident light is pulsed light, and detection of light is to be performed synchronously with the pulse timing, the reference signal for synchronous detection at the optical detector 8 and a signal controlling modulation of the pulsed light may be synchronized based on the reference clock.

Signals from the optical detector 8 pass through the analog/digital conversion circuit 57 and are temporarily saved in the primary memory 58. Data of a particular timing is selected based on the timing of vibration of the scanners as described above, and saved in a hard disk drive (HDD) or solid state drive (SSD) or the like. This process for selecting data is processed in a programmed manner in a data filter, and new data is overwritten to the memory. According to this process, at the time of obtaining a particular timing from the signals of the optical detector 8 obtained for each one-dimensional scan, i.e., a particular wavelength for the first wavelength, the data from the first light having the first wavelength having been irradiated can be selected and saved. This particular timing is calculated from the displacement timing of the optical scanning and wavelength sweeping scanners. An example of this method is the method illustrated in FIGS. 3B, 4B, and 5B, where the relation in change of the first wavelength and the change in the irradiation position, and the timings of the voltage signals of the optical scanning control signal generating circuit 54 and wavelength sweeping control signal generating circuit 52, are combined. This method enables the first wavelength to be obtained at a desired timing. The data to be saved includes at least voltage signals of the optical detector 8, and may be set to include displacement amount of the wavelength sweeping resonant scanner 23, the first wavelength, the second wavelength, and wavenumber difference data. The data storage unit 9 includes at least the analog/digital conversion circuit 57, primary memory 58, data filter 59, and storage 60. Control signals which control the components of the data storage unit 9 are generated at the data storage unit control signal generating circuit 56 based on the reference clock.

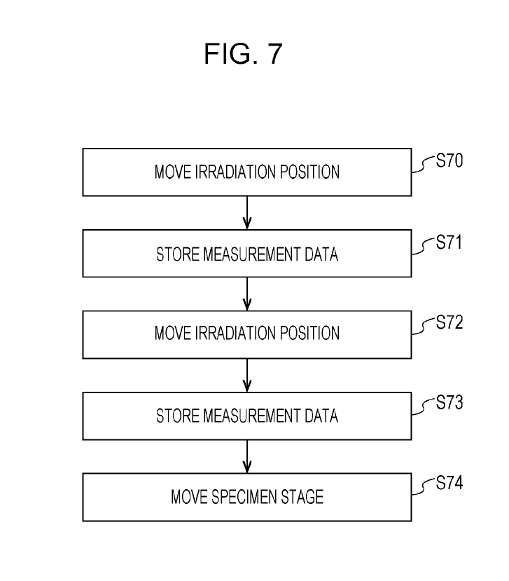

In the case of the scanning unit 5 performing one-dimensional scanning, the specimen stage 7 needs to be moved to measure a two-dimensional measurement range. FIG. 7 illustrates an exemplary flow process for irradiation and detection of light at various positions of a measurement specimen according to an embodiment. In the flow process of FIG. 7, at a process S70, the irradiation position of the scanning unit is moved to a desired position of the specimen. The specimen stage control circuit 64 generates signals to control the position of the specimen stage 7, and outputs the signals to the specimen stage 7, based on the reference clock. The processes S71 and S73 where measurement data is stored can be consecutively executed with the processes S70 and S72 to move the irradiation position by the one-dimensional scanning unit, and the process S74 to move the specimen stage 7 by the specimen stage driving unit 17, as illustrated in FIG. 7. Thus, two-dimensional data of the object to be measured can be continuously saved. The process to move the irradiation position by the one-dimensional scanning unit and the process to store measurement data are performed at the same time as the process in which the first wavelength is changed, and position data of the specimen stage 7 is also saved as data.

While the embodiment has been described in which resonant scanners are used for the wavelength changing unit and optical scanning unit, with reference to FIGS. 2 through 5D, the wavelength changing unit and optical scanning unit according to the present invention are not restricted thusly. An acousto-optic tunable filter, or polygon mirror type filter (described in S. H. Yun et al., “High-speed wavelength-swept semiconductor laser with a polygon-scanner-based wavelength filter”, Optics letters, vol. 28, no. 20, 1981-1983 (2003)), may be combined with the broadband light source 1 and used. It is sufficient for the optical filter used in the wavelength changing unit 2 to be able to change the wavelength of light under control voltage signals. In a case of using an optical filter, advantages similar to those in the case of using the wavelength changing unit 2 employing a resonant scanner can be obtained by using the wavelength sweeping control signal generating circuit 52 illustrated in FIG. 6 as a filter control signal circuit.

The optical scanning unit according to the present invention is not restricted to a resonant scanner; for example, a galvano scanner, electro-optic crystal, digital mirror device, or the like may be used. It is sufficient for the optical scanning unit to be a device which can change the irradiation position of light under control voltage signals. In the case of using any of the optical scanning units, advantages similar to those in the case of using the one-dimensional optical scanning unit employing a resonant scanner can be obtained by using the optical scanning control signal generating circuit 54 illustrated in FIG. 6 as these control signal circuits.

Alternatively, an arrangement may be made wherein the specimen 6 is scanned by irradiating the first light on multiple first regions thereof, with the first wavelength kept at λ1, and subsequently changing the first wavelength to λ2 and scanning the specimen 6 by irradiating the first light on multiple second regions thereof. Note however, that the first regions do not overlap each other, and the second regions do not overlap each other. Thus, even if first wavelength sweeping and specimen scanning is performed, the first light is not irradiated in the second regions when the first wavelength is λ1, and the first light is not irradiated in the first regions when the first wavelength is λ2, so the measurement amount data can be reduced as compared with the related art.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-125723, filed Jun. 14, 2013, and Japanese Patent Application No. 2014-093888, filed Apr. 30, 2014, which are hereby incorporated by reference herein in their entirety.

What is claimed is:

1. A measurement apparatus, comprising:
a first light source unit configured to emit a first light having a first wavelength; and
a scanning unit configured to move an irradiation position of the first light with respect to a specimen, so as to scan the specimen with the first light;
wherein the first light source unit includes
a wavelength changing unit configured to change the first wavelength;
wherein movement of the irradiation position with respect to the specimen is performed by the scanning unit while the wavelength changing unit is changing the first wavelength; and
wherein a changing cycle of the first wavelength by the wavelength changing unit is shorter than a position moving cycle by the scanning unit.

2. The measurement apparatus according to claim 1,
wherein the scanning unit scans the specimen with the first light such that
when the first wavelength is λ1, the first light is irradiated on a first region of the specimen but not irradiated on a second region of the specimen, and
when the first wavelength is λ2, the first light is not irradiated on the first region of the specimen but is irradiated on the second region of the specimen.

3. The measurement apparatus according to claim 1,
wherein the measurement apparatus is operable to perform
a high-speed measurement mode in which the scanning unit moves the irradiation position so as to measure the specimen, while changing of the first wavelength is being performed by the wavelength changing unit, and
a normal measurement mode in which the scanning unit does not move the irradiation position while changing of the first wavelength is being performed by the wavelength changing unit, and in which the specimen is measured without changing the first wavelength when the irradiation position is to be moved.

4. The measurement apparatus according to claim 1,
wherein the wavelength changing unit cyclically changes the first wavelength;
and wherein the scanning unit cyclically moves the irradiation position of the first light with respect to the specimen, so as to scan the specimen.

5. The measurement apparatus according to claim 4,
wherein a position movement cycle of the irradiation position by the scanning unit is a positive integer multiple of the first wavelength changing cycle by the wavelength changing unit.

6. The measurement apparatus according to claim 5,
wherein a phase of the first wavelength changing cycle by the wavelength changing unit matches a phase of the position movement cycle of the irradiation position by the scanning unit.

7. The measurement apparatus according to claim 4,
wherein a phase difference exists between the phase of the first wavelength changing cycle by the wavelength changing unit and the phase of the position movement cycle of the irradiation position by the scanning unit;
and wherein a range over which the first wavelength is changed while the irradiation position is moved by the scanning unit from a first region of the specimen to a third region, and a range over which the first wavelength is changed while the irradiation position is moved by the scanning unit from the third region of the specimen to a first region, are different.

8. The measurement apparatus according to claim 1, further comprising:
a second light source configured to emit a second light having a second wavelength; and
a multiplexing unit configured to multiplex the first light and the second light;
wherein the scanning unit scans the specimen with the first light, by scanning the specimen with multiplexed light which has been multiplexed by the multiplexing unit;
and wherein the wavelength changing unit changes a wavenumber difference of the multiplexed light, by changing the first wavelength, wherein the wavenumber difference is the difference of the wavenumber of the first light and the wavenumber of the second light included in the multiplexed light.

9. The measurement apparatus according to claim 8,
wherein the wavelength changing unit changes the first wavelength and the second wavelength.

10. The measurement apparatus according to claim 8,
wherein the wavelength changing unit cyclically changes the wavenumber difference of the multiplexed light.

11. The measurement apparatus according to claim 10,
wherein the scanning unit cyclically moves the irradiation position of the first light with respect to the specimen, so as to scan the specimen;
and wherein the irradiation position movement cycle by the scanning unit is obtained by multiplying the wavenumber difference changing cycle of the multiplexed light by a positive integer.

12. The measurement apparatus according to claim 11,
wherein a phase of the changing cycle of the wavenumber difference of the multiplexed light matches a phase of the position movement cycle of the irradiation position.

13. The measurement apparatus according to claim 11,
wherein a phase difference exists between the phase of the changing cycle of the wavenumber difference of the multiplexed light and the phase of the position movement cycle of the irradiation position;
and wherein a range over which the wavenumber difference of the multiplexed light is changed while the irradiation position is moved by the scanning unit from the first region of the specimen to the third region, and a range over which the wavenumber difference of the multiplexed light is changed while the irradiation position is moved by the scanning unit from the third region of the specimen to the first region, are different.

14. The measurement apparatus according to claim 1,
wherein the measurement apparatus is operable to perform a wide-range scan and a narrow-range scan;
wherein a measurement mode in which the narrow-range scan is a measurement mode where the number of wavenumbers irradiate to one position is greater than that of a measurement mode in which the wide-range scan is performed;
and wherein the narrow-range scan is performed as to a region set using measurement results of the specimen from the wide-range scan.

15. The measurement apparatus according to claim 14,
wherein the region where the narrow-range scan is performed is set using results obtained by having performed multivariable analysis on the measurement results of the specimen from the wide-range scan.

16. A specimen information obtaining system comprising:
the measurement device according to claim 1;
a detector configured to detect light from the specimen; and
an information processing device configured to acquire information of the specimen by processing information of the detection results from the detector.

17. The specimen information obtaining system according to claim 16, further comprising:
an image display device configured to receive input of image information based on information of the specimen from the information processing device, and to display images based on the image information.

18. A measurement apparatus, comprising:
a first light source unit configured to emit a first light having a first wavelength;
a scanning unit configured to scan a specimen with the first light; and
a wavelength changing unit configured to change the first wavelength;
wherein the scanning unit scans the specimen with the first light such that
when the first wavelength is A, the first light is irradiated on a first region of the specimen but not irradiated on a second region of the specimen, and
when the first wavelength is B, the first light is not irradiated on the first region of the specimen but is irradiated on the second region of the specimen
and wherein a changing cycle of the first wavelength by the wavelength changing unit is shorter than a position moving cycle by the scanning unit.

19. A specimen information obtaining system comprising:
the measurement device according to claim 18;
a detector configured to detect light from the specimen; and
an information processing device configured to acquire information of the specimen by processing information of the detection results from the detector;
wherein the information processing device obtains information of the specimen in a fourth region, using detection results obtained by irradiating the first light on the first region, and detection results obtained by irradiating the first light on the second region.

20. A measurement apparatus, comprising:
a first light source unit configured to emit a first light having a first wavelength;
a second light source unit configured to emit a second light having a second wavelength;
a multiplexing unit configured to multiplex the first light and the second light to form multiplexed light; and
a scanning unit configured to move the irradiation position of the multiplexed light with respect to a specimen and scan the specimen with the multiplexed light;
wherein the first light source unit has a wavelength changing unit configured to change the first wavelength;
wherein the second light source unit has a wavelength changing unit configured to change the second wavelength;
wherein the irradiation position is moved by the scanning unit while changing of vibration frequency difference of the multiplexed light is performed by at least one of the wavelength changing unit of the first light source unit and the wavelength changing unit of the second light source unit;
and wherein a changing cycle of the vibration frequency difference is shorter than a position moving cycle by the scanning unit.
